(19) United States
(12) Patent Application Publication
(10) Pub. No.: US 2024/0135003 A1
(43) Pub. Date: Apr. 25, 2024

(54) METHOD AND DEVICE FOR BUILDING VULNERABILITY DATABASE

(71) Applicant: Korea University Research and Business Foundation, Seoul (KR)

(72) Inventors: Heejo LEE, Seongnam-si (KR); Hyunji HONG, Seoul (KR)

(73) Assignee: Korea University Research and Business Foundation, Seoul (KR)

(21) Appl. No.: 18/142,257

(22) Filed: May 1, 2023

(30) Foreign Application Priority Data
Oct. 24, 2022 (KR) 10-2022-0138414

(51) Int. Cl. G06F 21/57; G06F 21/55

(52) U.S. Cl. CPC G06F 21/577; G06F 21/552

(57) ABSTRACT

According to some exemplary embodiments of the present disclosure, disclosed is a method for building a vulnerability database, which is performed by a computing device. The method may include collecting a security patch from a data source based on a direct patch link; collecting the security patch from the data source based on an indirect patch link; and collecting the security patch from the data source based on an invisible patch link. The patch information of a vulnerability can be used for verifying the existence of the vulnerability, as well as fixing the vulnerability of target software.

### CROSS-REFERENCE TO RELATED APPLICATIONS

This application claims priority to and the benefit of Korean Patent Application No. 10-2022-0138414 filed in the Korean Intellectual Property Office on Oct. 25, 2022, the entire contents of which are incorporated herein by reference.

### TECHNICAL FIELD

The present disclosure relates to a method and a device for building a vulnerability database.

### BACKGROUND ART

Open source software (OSS) refers to software which anyone can use within a scope of following a license because a source code is released. The open source software (OSS) can contribute to rapid software development by allowing reuse, redistribution, and modification of the source code, but if the OSS is not properly managed when the OSS is reused, a problem as vulnerability propagation can be caused.

In order to solve such a problem, developers generally updates a vulnerable version or modifies a vulnerable source code by utilizing CVE information which is an opened security vulnerability and exposure list. In particular, it is necessary to build a vulnerability database loaded with a security patch and the vulnerability source code in order to modify the vulnerable source code.

Despite the importance of the vulnerability database, conventional studies have two limitations in collecting vast amounts of security patches. Specifically, a first limitation is that a data source where the security patch is collected is limited. A second limitation is that security patches are collected only through shallow scanning Vulnerability information is scattered in various data sources (for example, repository and issue trackers, etc.), but in most conventional studies, a method for collecting the security patches only in the repository ‘Github’ was considered. In addition, in many conventional studies, since only patches which can be directly imported from a reference URL provided by a ‘National Vulnerability Database (NVD)’ which is a vulnerability public database are scanned and collected, many security patches cannot be collected.

Therefore, there is a demand for technology that can collect even security patches that cannot be imported directly from the ‘NVD’ in consideration of various data sources.

### SUMMARY OF THE INVENTION

The present disclosure is contrived in response to the above-described background art, and has been made in an effort to provide a method and a device for building a vulnerability database by collecting security patches based on a directly patch link, an indirect patch link, and an invisible patch link.

An exemplary embodiment of the present disclosure provides a method for building a vulnerability database, which is performed by a computing device. The method may include collecting a security patch from a data source based on a direct patch link; collecting the security patch from the data source based on an indirect patch link; and collecting the security patch from the data source based on an invisible patch link.

Alternatively, the collecting of the security patch from the data source based on the direct patch link may include identifying a security patch link having a predetermined pattern on a vulnerability information page, and collecting the security patch from a security patch page connected through the security patch link.

Alternatively, the predetermined pattern may include vulnerability data source domain name information and security patch identification character string information.

Alternatively, the collecting of the security patch from the data source based on the indirect patch link may include crawling a website address identified on the vulnerability information page, acquiring a security patch link having a predetermined pattern or predetermined hint information, and collecting the security patch based on the security patch link or the predetermined hint information.

Alternatively, the collecting of the security patch based on the security patch link or the predetermined hint information may include collecting the security patch from a security patch page connected through the security patch link.

Alternatively, the predetermined pattern may include vulnerability data source domain name information and security patch identification character string information.

Alternatively, the collecting of the security patch based on the security patch link or the predetermined hint information may include collecting a patch commit corresponding to the predetermined hint information.

Alternatively, the predetermined hint information may include commit ID information or bug ID information.

Alternatively, the collecting of the security patch from the data source based on the invisible patch link may include collecting a Q&A post from a Q&A site, extracting a change history of the collected Q&A post, identifying change information corresponding to a predetermined feature from the extracted change history, and acquiring an insecure code snippet based on the identified change information.

Alternatively, the predetermined feature may include changes in a security-sensitive API, a security-related to keyword, and a control flow.

Alternatively, the collecting of the security patch from the data source based on the invisible patch link may include searching a commit message including CVE ID information in a repository or an issue tracker.

Alternatively, the collecting of the security patch from the data source based on the invisible patch link may include collecting the security patch from the search commit message by analyzing the searched commit message based on the predetermined feature.

Another exemplary embodiment of the present disclosure provides a computer program stored in a computer-readable medium, in which the computer program includes instructions for allowing one or more processors to perform a method for building a vulnerability database, and the method may include: collecting a security patch from a data source based on a direct patch link; collecting the security patch from the data source based on an indirect patch link; and collecting the security patch from the data source based on an invisible patch link.

Still another exemplary embodiment of the present disclosure provides a computing device for performing a method for building a vulnerability database. The computing device may include a memory including computer executable components; and a processor executing the following computer executable components stored in the memory, in which the processor may collect a security patch from a data source based on a direct patch link, collect the security patch from the data source based on an indirect patch link, and collect the security patch from the data source based on an invisible patch link.

According to exemplary embodiments of the present disclosure, a method and a device for building a vulnerability database by collecting security patches based on a directly patch link, an indirect patch link, and an invisible patch link can be provided.

The patch information of a vulnerability can be used for verifying the existence of the vulnerability, as well as fixing the vulnerability of target software.

### BRIEF DESCRIPTION OF THE DRAWINGS

FIG. 1 is a diagram illustrating a block diagram of a computing device performing an operation for providing a method for building a vulnerability database according to some exemplary embodiments of the present disclosure.

FIG. 2 is a schematic diagram for a method for building a vulnerability database according to some exemplary embodiments of the present disclosure.

FIG. 3 is a conceptual diagram for describing an operation of a security patch collection unit according to some exemplary embodiments of the present disclosure.

FIG. 4 is a diagram for describing an exemplary embodiment of collecting security patches by using a direct patch link according to some exemplary embodiments of the present disclosure.

FIG. 5 is a diagram for describing an exemplary embodiment of collecting security patches by using an indirect patch link according to some exemplary embodiments of the present disclosure.

FIG. 6 is another diagram for describing the exemplary embodiment of collecting security patches by using an indirect patch link according to some exemplary embodiments of the present disclosure.

FIG. 7 is a diagram for describing an exemplary embodiment of collecting security patches by using an invisible patch link according to some exemplary embodiments of the present disclosure.

FIG. 8 is a graph of the year distribution of CVE patches in xVDB according to some exemplary embodiments of the present disclosure.

FIG. 9 is a graph of the distribution of reference sites of CVE patches in xVDB according to some exemplary embodiments of the present disclosure.

FIG. 10 is a flowchart of a method for building a vulnerability database according to some exemplary embodiments of the present disclosure.

FIG. 11 is a block diagram of a computing device according to some exemplary embodiments of the present disclosure.

### DETAILED DESCRIPTION

Hereinafter, various exemplary embodiments are described with reference to the drawings. In the present specification, various descriptions are presented for understanding the present disclosure. However, it is obvious that the exemplary embodiments may be carried out even without a particular description.

Terms, “component”, “module”, “system” and the like used in the present specification indicate a computer-related entity, hardware, firmware, software, a combination of software and hardware, or execution of software. For example, a component may be a procedure executed in a processor, a processor, an object, an execution thread, a program, and/or a computer, but is not limited thereto. For example, both an application executed in a computing device and the computing device may be components. One or more components may reside within a processor and/or an execution thread. One component may be localized within one computer. One component may be distributed between two or more computers. Further, the components may be executed by various computer readable media having various data structures stored therein. For example, components may communicate through local and/or remote processing according to a signal (for example, data transmitted to another system through a network, such as Internet, through data and/or a signal from one component interacting with another component in a local system and a distributed system) having one or more data packets.

A term “or” intends to mean comprehensive “or” not exclusive “or”. That is, unless otherwise specified or when it is unclear in context, “X uses A or B” intends to mean one of the natural comprehensive substitutions. That is, when X uses A, X uses B, or X uses both A and B, “X uses A or B” may be applied to any one among the cases. Further, a term “and/or” used in the present specification shall be understood to designate and include all of the possible combinations of one or more items among the listed relevant items.

A term “include” and/or “including” shall be understood as meaning that a corresponding characteristic and/or a constituent element exists. Further, a term “include” and/or “including” means that a corresponding characteristic and/or a constituent element exists, but it shall be understood that the existence or an addition of one or more other characteristics, constituent elements, and/or a group thereof is not excluded. Further, unless otherwise specified or when it is unclear that a single form is indicated in context, the singular shall be construed to generally mean “one or more” in the present specification and the claims.

The term “at least one of A and B” should be interpreted to mean “the case including only A”, “the case including only B”, and “the case where A and B are combined”.

Those skilled in the art shall recognize that the various illustrative logical blocks, configurations, modules, circuits, means, logic, and algorithm operations described in relation to the exemplary embodiments additionally disclosed herein may be implemented by electronic hardware, computer software, or in a combination of electronic hardware and computer software. In order to clearly exemplify interchangeability of hardware and software, the various illustrative components, blocks, configurations, means, logic, modules, circuits, and operations have been generally described above in the functional aspects thereof. Whether the functionality is implemented as hardware or software depends on a specific application or design restraints given to the general system. Those skilled in the art may implement the functionality described by various methods for each of the specific applications. However, it shall not be construed that the determinations of the implementation deviate from the range of the contents of the present disclosure.

The description about the presented exemplary embodiments is provided so as for those skilled in the art to use or carry out the present invention. Various modifications of the exemplary embodiments will be apparent to those skilled in the art. General principles defined herein may be applied to other exemplary embodiments without departing from the scope of the present disclosure. Therefore, the present invention is not limited to the exemplary embodiments presented herein. The present invention shall be interpreted within the broadest meaning range consistent to the principles and new characteristics presented herein.

In an exemplary embodiment of the present disclosure, a server may also include other configurations for performing a server environment of the server. The server may include any type of device. The server is a digital device and may be a digital device, such as a laptop computer, a notebook computer, a desktop computer, a web pad, and a mobile phone, which is mounted with a processor, includes a memory, and has calculation ability. The server may be a web server processing a service. In an embodiment of the present disclosure, the point management server can provide a new and improved point management system using a plurality of merchant servers and point servers by performing the method of managing points described below. The foregoing kind of server is merely an example, and the present disclosure is not limited thereto.

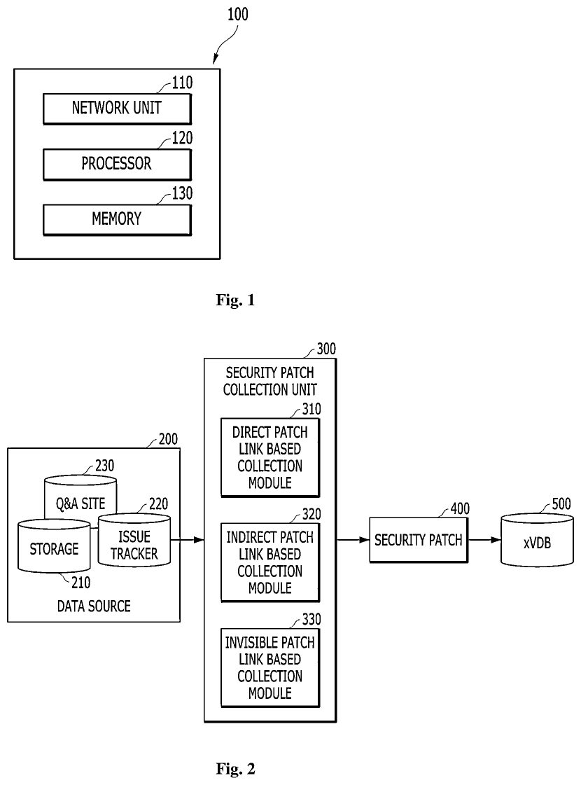

FIG. 1 is a block diagram of a computing device performing an operation for providing a method for building a vulnerability database according to some exemplary embodiments of the present disclosure.

As illustrated in FIG. 1, a computing device 100 may include a processor 110, a memory 120, and a network unit 130. A configuration of the computing device 100 illustrated in FIG. 1 is only an example simplified and illustrated. In some exemplary embodiments of the present disclosure, the computing device 100 may include other components for performing a computing environment of the computing device 100, and only some of the disclosed components may constitute the computing device 100.

The processor 110 may be constituted by one or more cores, and include processors for data analysis and processing, such as a central processing unit (CPU), a general purpose graphics processing unit (GPGPU), a tensor processing unit (TPU), etc., of the computing device. The processor 110 may read a computer program stored in the memory 120, and according to some exemplary embodiments of the present disclosure, the processor 110 may implement a security patch collection unit and modules of thereof for performing a method for building a vulnerability database. In addition, the processor 110 may perform data conversion, operation, generation, etc., for performing the method for building a vulnerability database according to some exemplary embodiments of the present disclosure. In addition, the computer program performed by the computing device according to some exemplary embodiments of the present disclosure may be a CPU, GPGPU, or TPU executable program.

According to some exemplary embodiments of the present disclosure, the memory 120 may store arbitrary form of information generated or determined by the processor 110 or arbitrary form of information received by the network unit 130. The memory 120 may store data generated in a process of performing the method for building the vulnerability database by the processor 110. For example, the memory 120 may store security patches generated according to the method for building the vulnerability database according to some exemplary embodiments of the present disclosure. Further, the memory 120 may store data received from the outside in the process of performing the method for building the vulnerability database by the processor 110. For example, the memory 120 may store data received from a data source in the process of performing the method for building the vulnerability database by the processor 110. However, although not limited thereto, and the memory 120 may store various information for performing a method for analyzing a medical image according to some exemplary embodiments of the present disclosure.

The memory 120 according to some exemplary embodiments of the present disclosure may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The computing device 100 may also operate in connection with a web storage performing a storing function of the memory 120 on the Internet. The disclosure of the memory is just an example, and the present disclosure is not limited thereto.

The network unit 130 according to some exemplary embodiments of the present disclosure may use an arbitrary type of known wired/wireless communication system.

The network unit 130 may transmit and receive information processed by the processor 110, a user interface, etc., through communication with the other terminal. For example, the network unit 130 may provide the user interface generated by the processor 110 to a client (e.g., a user terminal). Further, the network unit 130 may receive an external input of a user applied to the client, and transfer the received external input to the processor 110. In this case, the processor 110 may process operations such as output, modification, change, addition, etc., of information provided through the user interface based on the external input of the user transferred from the network unit 130.

Specifically, for example, the network unit 130 may transmit and receive various information for performing the method for building the vulnerability database according to some exemplary embodiments of the present disclosure. For example, the network unit 130 may receive security issue related data stored in the data source including various repositories, issue trackers, and Q&A sites. Further, the network unit 130 may transmit some data generated in the process of performing the method for building the vulnerability database according to some exemplary embodiments of the present disclosure to the outside in order to store some data in the vulnerability database.

Meanwhile, the computing device 100 according to some exemplary embodiments of the present disclosure may include a server as a computing system that transmits and receives information to and from the client through communication. At this time, the client may be an arbitrary type of terminal which may access the server. For example, the computing device 100 which is the server may receive a query from the user terminal, and generate a single information processing result corresponding to the query. In this case, the computing device 100 which is the server may provide the user interface including the processing result to the user terminal. At this time, the user terminal may output the user interface received from the computing device 100 which is the server, and receive or process the information through an interaction with the user.

In an additional exemplary embodiment, the computing device 100 may also include an arbitrary type of terminal that receives the data resource generated by the arbitrary server and performs additional information processing.

The present disclosure may provide a method and a device which can resolve a problem in that the vulnerability database has a dataset which is biased and has an insufficient dataset, which is generated by considering only one data source by collecting the security patches from various data sources. According to the present disclosure, the security patches may be collected from a data source which does not explicitly provide vulnerability information. According to the present disclosure, the security patches may be collected when there is no direct connectivity between a patch commit URL and a corresponding CVE vulnerability (invisible link). Consequently, the present disclosure may provide a method and a device which may collect the security patches from various data sources by an automated methodology.

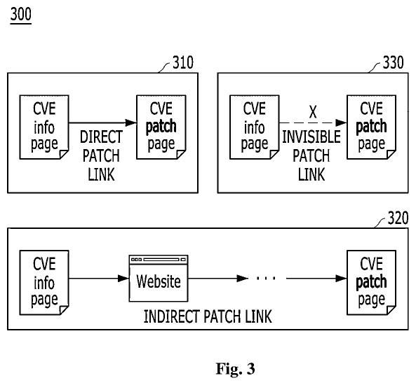

FIG. 2 is a schematic diagram for a method for building a vulnerability database according to some exemplary embodiments of the present disclosure.

The processor 110 may collect security patches for a vulnerability which is known or unknown on the data source 200. Here, the known vulnerability may include a vulnerability managed by a public vulnerability database by allocating a CVE ID. The unknown vulnerability may include a vulnerability not managed by the CVE. For example, the unknown vulnerability may include a vulnerability secretly patched, and not managed by the public vulnerability database.

According to some exemplary embodiments of the present disclosure, in order to avoid a limitation by a limited data source, the processor 110 may collect security patches 400 from three types of data sources 200. For example, the data source 200 may include repositories, issue trackers, and Q&A sites.

In some examples, the repository may be a keeping space for storing a collection of various versions of files of software programs. The repository may be a site for managing software codes. For example, the repository may include ‘GitHub’.

In some examples, the issue tracker may include tools for tracking a bug of a software supplier, and managing other issues. The issue tracker may be a site which manages a security related bug and vulnerability. For example, the issue tracker may include ‘Bugzilla’.

In some examples, the Q&A site may include a platform that discusses a code problem. The Q&A site may be a site which is not managed by the public vulnerability database such as a National Vulnerability Database (NVD), but generates and propagates insecure code snippets. For example, the Q&A site may include ‘Stack Overflow’.

The example of the data source 200 is just an example, and the data source 200 may include various repositories, issue trackers, and Q&A sites.

The processor 110 may implement the security patch collection unit 300 that performs various operations for collecting the security patches 400 from the data source 200. In some examples, the security patch collection unit 300 may collect the security patches by directly or indirectly using security related information such as the CVE information stored in the data source 200. Further, the security patch collection unit 300 may collect a security patch which is invisible from the CVE information, but may be acquired from the data source 200. In some examples, the security patch collection unit 300 may include a direct patch link based collection module 310, an indirect patch link based collection module 320, and an invisible patch link based collection module 330. Exemplary operations of the security patch collection unit 300 including the direct patch link based collection module 310, the indirect patch link based collection module 320, and the invisible patch link based collection module 330 will be described below in detail with reference to FIGS. 3 to 8.

The processor 110 may collect the security patches 400 from the data source 200 by the security patch collection unit 300. In some examples, the security patch 400 may include a source code-level patch applied to solve security issues. For example, the security patch 400 may be provided in a ‘cliff’ form of a code before and after application of the patch. The exemplary security patch 400 shown in Table 1 shows a security patch fragment for a vulnerability standard code ‘CVE-2021-41216’ regarding a heap buffer overflow vulnerability in a tensor flow.

TABLE 1

| | |
|---|---|
| 1 | diff --git a/tensorflow/core/ops/array_ops.cc |
| 2 | b/tensorflow/core/ops/array_ops.cc |
| 3 | index 64bd4f3847854..14c9efae1ddd3 100644 |
| 4 | −−− a/tensorflow/core/ops/array_ops.cc |
| 5 | +++ b/tensorflow/core/ops/array_ops.cc |
| 6 | |
| 7 | [symbol] Status TransposeShapeFn(...) { |
| 8 | |
| 9 | for (int32_t i = 0; i < rank; ++i) { |
| 10 | int64_t in_idx = data[i]; |
| 11 | − if (in_idx >= rank) { |
| 12 | + if (in_idx >= rank \|\| in_idx <= -rank) { |
| 13 | return errors::InvalidArgument(“perm dim ”, |
| | in_idx, “ is out of range of input rank ”, |
| | rank) ; |
| 14 | } |

[symbol]

indicates data missing or illegible when filed

The security patch 400 may provide information for efficient vulnerability management. For example, the security patch 400 may provide information on a source file patched with the vulnerability (e.g., in Table 1, “array_ops.cc”). The security patch 400 may provide information on a file index value before and after applying the patch (e.g., line #3 in Table 1). Further, the security patch 400 may provide information on a code line number to which the patch is applied (e.g., in Table 1, 7 lines from line #168 in the file “array_ops.cc”). The security patch 400 may provide information on actual code lines added to or deleted from the security patch (e.g., in Table 1, line #11 and line #12). However, although not limited thereto, and the security patch 400 may provide various information in various forms.

The processor 110 may store the security patch 400 collected by the security patch collection unit 300 in the vulnerability database. The exemplary vulnerability database built according to the method and the device according to some exemplary embodiments of the present disclosure may have a wide coverage by possessing a security patch which may be collected from the vulnerability public database such as the ‘NVD’ and a security patch which may not be collected from the vulnerability public database. The vulnerability database according to some exemplary embodiments of the present disclosure enables whether there is the vulnerability which may not be detected by a conventional scheme to be detected by collecting multiple security patches which may not be directly acquired from the vulnerability public database to provide an effect of enhancing the software security.

Hereinafter, an exemplary embodiment of building the vulnerability database according to some exemplary embodiments of the present disclosure will be described with reference to FIGS. 3 to 7.

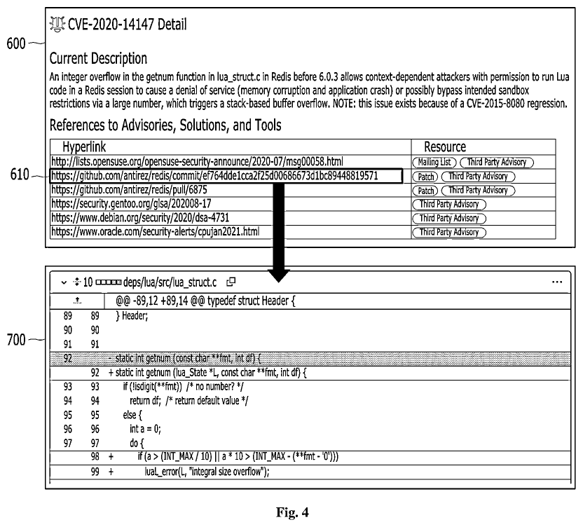

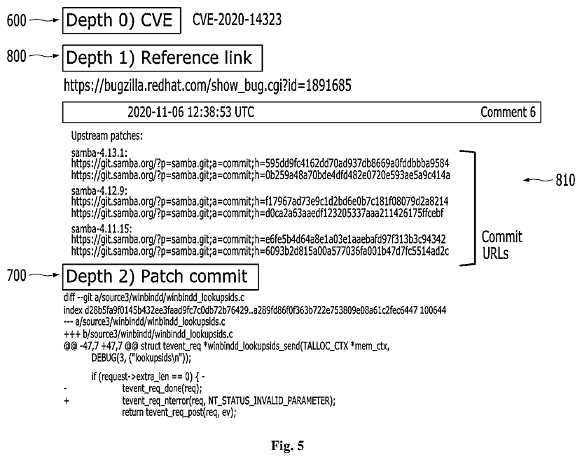

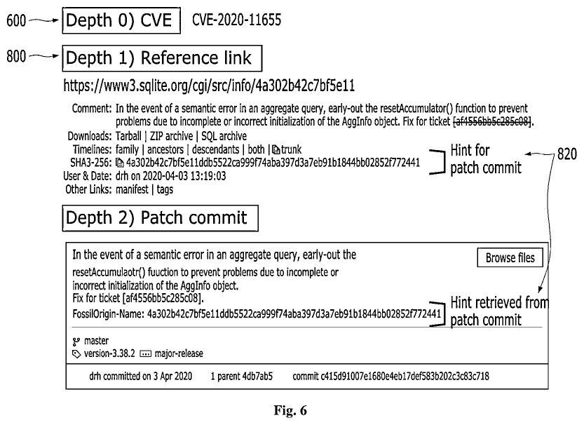

FIG. 3 is a conceptual diagram for describing an operation of a security patch collection unit according to some exemplary embodiments of the present disclosure. FIG. 4 is a diagram for describing an exemplary embodiment of collecting security patches by using a direct patch link according to some exemplary embodiments of the present disclosure. FIG. 5 is a diagram for describing an exemplary embodiment of collecting security patches by using an indirect patch link according to some exemplary embodiments of the present disclosure. FIG. 6 is another diagram for describing the exemplary embodiment of collecting security patches by using an indirect patch link according to some exemplary embodiments of the present disclosure. FIG. 7 is a diagram for describing an exemplary embodiment of collecting security patches by using an invisible patch link according to some exemplary embodiments of the present disclosure.

The security patch collection unit 300 may acquire link information capable of collecting the security patch from a vulnerability information page provided by the data source 200. The security patch collection unit 300 may collect the security patch from a security patch page or a security related information page of various data sources 200 by using the collected link information.

In some examples, the vulnerability information page may include a page providing information on the vulnerability in the public vulnerability database such as the NVD, the CVE, or MITRE. For example, the vulnerability information page may include a page providing information on each CVE in the public vulnerability database. In the present disclosure, the vulnerability information page may also be referred to as a CVE info page.

The security patch page may include a page providing the security patch for the vulnerability. For example, the security patch page may include a page providing the security patch for the CVE vulnerability. In the present disclosure, the security patch page may also be referred to as a CVE patch page.

The security patch collection unit 300 may collect the security patch 400 from the data source 200 by using three types of links defined according to some exemplary embodiments of the present disclosure. Referring to FIG. 3, three exemplary types of links may include a direct patch link, an indirect patch link, and an invisible patch link. In some examples, the security patch collection unit 300 may acquire information on the direct patch link, the indirect patch link, and the invisible patch link by parsing or crawling a web page referred for the vulnerability information page and the vulnerability information page. Three modules 310, 320, and 330 of the security patch collection unit 300 may collect the security patch by acquiring the direct patch link, the indirect patch link, and the invisible patch link from the vulnerability information page. In some examples, the direct patch link may include a link connected directly from the vulnerability information page to the security patch page. In some examples, the indirect patch link may include hint information capable of searching a link or a patch commit connected to the security patch page from the web page connected from the vulnerability information page. In some examples, the invisible patch link may include a link and information capable of collecting the security patch other than the link connected to the security patch page. An operation of a module based on each patch link type will be described below.

According to some exemplary embodiments of the present disclosure, the direct patch link based collection module 310 may collect the security patch from the data source based on the direct patch link.

Specifically, the direct patch link based collection module 310 may identify a security patch link having a predetermined pattern on the vulnerability information page. Referring to FIG. 4, the direct patch link based collection module 310 may identify a security patch link 610 having a predetermined pattern on the vulnerability information page 600 of the NVD public vulnerability database. Here, the predetermined pattern may include vulnerability data source domain name information and security patch identification character string information. The security patch link 610 includes vulnerability data source domain name information ‘github.com’ and security patch identification character string information ‘commit’ In this case, the direct patch link based collection module 310 may directly access a security patch page 700 of the repository 210 through the security patch link 610. The direct patch link based collection module 310 may collect the security patch from the security patch page 700 accessed through the security patch link 610. For example, the direct patch link based collection module 310 may download a clone repository to a local environment of the computing device 100 by using a command ‘git clone repository_url’. In addition, the direct patch 1 ink based collection module 310 may extract ‘cliff’s related to commit a searched commit by using a command ‘git show corn-mit_id’ in the clone repository. However, although not limited thereto, and the direct patch link based collection module 310 may operate in various schemes.

According to some exemplary embodiments of the present disclosure, the indirect patch link based collection module 320 may collect the security patch from the data source based on the indirect patch link.

Specifically, the indirect patch link based collection module 320 may crawl a website address identified on the vulnerability information page. In some examples, the website address identified on the vulnerability information page may be crawled by using a crawler such as ‘BeautifulSoup’. Referring to FIG. 5, the indirect patch link based collection module 320 may identify ‘http://bugzillasedhat.com/show_bug.cgi?id=1891685’ which is a website address of the issue tracker identified on the vulnerability information page 600 for ‘CVE-2020-14323’. In this case, the indirect patch link based collection module 320 may crawl the identified website address of the issue tracker by using the crawler.

Through crawling, the indirect patch link based collection module 320 may acquire a security patch link having a predetermined pattern or predetermined hint information for the security patch link. For example, as a first case, the indirect patch link based collection module 320 may identify the security patch link having the predetermined pattern. Similarly to the exemplary embodiment of the direct patch link based collection module 310, the predetermined pattern may include the vulnerability data source domain name information and the security patch identification character string information. When acquiring the security patch link having the predetermined pattern, the indirect patch link based collection module 320 may collect the security patch from the security patch page connected through the security patch link. An operation of collecting the security patch through the security patch link by the indirect patch link based collection module 320 may be the same as the operation of the direct patch link based collection module 310.

As a second case, the indirect patch link based collection module 320 may identify predetermined hint information. Here, the predetermined hint information may include commit ID information or bug ID information. Referring to FIG. 6, by crawling ‘https://www3.sqlite.org/‘cgi/src/info/4a302b42c7bf5e11’ which is the website address of the issue tracker identified on the vulnerability information page 600 for ‘CVE-2020-11655’, the indirect patch link based collection module 320 may acquire a bug ID 82 which is an SHA3-256 hash value as the predetermined hint information. When acquiring the predetermined hint information, the indirect patch link based collection module 320 may collect a patch commit corresponding to the predetermined hint information. Referring to FIG. 6, an example in which a related commit having the bug ID 82 is searched in a commit message is illustrated. In addition, the indirect patch link based collection module 320 may collect the security patch by outputting the ‘cliff’s from the searched commit. However, although not limited thereto, and the indirect patch link based collection module 320 may operate in various schemes.

According to some exemplary embodiments of the present disclosure, the invisible patch link based collection module 330 may collect the security patch from the data source based on the invisible patch link.

Specifically, the invisible patch link based collection module 330 may collect a Q&A post from the Q&A site. In some examples, the invisible patch link based collection module 330 may be implemented based on ‘Dicos’ disclosed in “Dicos: Discovering insecure code snippets from stack overflow posts by leveraging user discussions”, in which the entire contents of which are incorporated herein by reference.

In some examples, the invisible patch link based collection module 330 may extract a change history of the collected Q&A post. For example, referring to FIG. 7, the invisible patch link based collection module 330 compares an oldest version and a latest version through an edit log of the Q&A post to extract a ‘cliff’ type change history for a description 921 and a code snippet 922 included in a Q&A column 920 of a post 900.

The invisible patch link based collection module 330 may identify change information corresponding to a predetermined feature from the extracted change history. Here, the predetermined feature may include changes in a security-sensitive API, a security-related to keyword, and a control flow. The invisible patch link based collection module 330 may acquire an insecure code snippet based the identified change information. For example, the invisible patch link based collection module 330 analyzes whether the extracted change information is to solve the security issue based on the predetermined feature to acquire the insecure code snippet as the security patch.

The invisible patch link based collection module 330 may search a commit message including CVE ID information from the repository or the issue tracker. Since the commit may be handled as a concept such as the change history, an insecure code snippet type security patch may be additionally collected by analyzing the commit message and the diff of the source code. For example, since the CVE ID information may provide a hint for finding the related commit, the invisible patch link based collection module 330 analyzes whether the commit message includes “CVE-20” to search a patch commit (e.g., a command ‘git log-grep=‘CVE-20’ may be used). The invisible patch link based collection module 330 analyzes whether the searched commit is to solve the security issue based on the predetermined feature to collect the security patch from the searched commit. However, although not limited thereto, and the invisible patch link based collection module 330 may operate in various schemes.

Table 2 below shows the data source 200 capable of collecting the security patch according to each link type.

TABLE 2

| | Type of link | | |
|---|---|---|---|
| Data source | Direct | Indirect | Invisible |
| Repositories | ✓ | ✓ | ✓ |
| Issue trackers | | ✓ | ✓ |
| Q&A sites | | | ✓ |

As seen from Table 2, unlike a conventional methodology in which the data source is limited to a single repository such as Git-hub, the method of the present disclosure may collect the security patch through three types of links which may consider a hidden connectivity between various data sources and the public vulnerability database.

Table 3 below shows an exemplary algorithm of the security patch collection unit 300.

TABLE 3
Algorithm 1: Algorithm for Collecting Security Patches

Input: V, C, R
// V: Vulnerability, C: CVE info
page, [symbol]
// R: Repository reporting V
Output: P
// P: Security patch for V

| 1 | procedure Ex ractingPatch( V, C, R) | | | | |
|---|---|---|---|---|---|
| 2 | \| | Ref ← References( V, C) | | | |
| 3 | \| | for URL in Ref do | | | |
| 4 | \| | \| | if (“git” in URL) and (“commit” in URL) | | |
| | \| | \| | then | | |
| | \| | \| | \| | // Collect P with direct | |
| | \| | \| | \| | patch Links | |
| 5 | \| | \| | \|_{—} | P ← Crawl( URL) | |
| 6 | \| | \| | else | // Collect P with indirect | |
| | \| | \| | \| | patch links | |
| 7 | \| | \| | \| | if [symbol] GitURL in Visit( URL) then | |
| 8 | \| | \| | \| | \| | P ← Crawl( GitURL) |
| | \| | \| | \| | \|_{—} | |
| 9 | \| | \| | \| | else if H in Visit( URL) then | |
| | \| | \| | \| | \| | // H: Hints for detecting |
| | \| | \| | \| | \| | patches (e.g., Commit ID |
| | \| | \| | \| | \| | ox Bug ID) |
| 10 | \| | \| | \| | \| | for Cₘ in R do |
| | \| | \| | \| | \|_{—} | \| // Cₘ; Commit |

| | | | | |
|---|---|---|---|---|
| 11 | \| | \| | \|_{—} | \| P ← GetPatchCommit( Cₘ, |

| | | |
|---|---|---|
| \| | \|_{—} | \|_H) |

| | \| // Collect P with Invisible Patch | | | |
|---|---|---|---|---|
| | links | | | |
| 12 | \| for Cₘ in R do | | | |
| | | \| if “CVE-20” in Cₘ then | | |
| | \| | \| | \| if (IsControlFlowChanged( Cₘ) or | \| |
| 14 | \| | \| | \|IsSecurityAPIChanged( Cₘ)) /then | \|_P ← Cₘ |

| | | |
|---|---|---|
| \| | \| | \|_{—} |

| | |
|---|---|
| \| | \|_{—} |

| | |
|---|---|
| 16 | \|_ return P |

[symbol]

indicates data missing or illegible when filed

According to the method for building the vulnerability database according to some exemplary embodiments of the present disclosure, the present inventor conducts an experiment of building the vulnerability database called ‘xVDB’. A result is disclosed in ‘xVDB: A High-Coverage Approach for Constructing a Vulnerability Database’, in which the entire contents of which are incorporated herein by reference.

The experiment is implemented as approximately 1000 lines of python codes except for an external library (e.g., BeautifulSoup). ‘Dicos’ which is an open source tool is used for collecting the security patch through the invisible patch link in the Q&A site. The source code of ‘Dicos’ is published in ‘https://github.com/hyunji-hong/DICOS-public’.

TABLE 4

| | | | | | | | Total |
|---|---|---|---|---|---|---|---|
| | Direct | Indirect | | Invisible | | | 4,076 |
| Approach | R* | R* | IT^{†} | R* | IT^{†} | QA^{††} | CVE |
| PatchDB | 4,076 | X | X | X | X | X | 12,432 |
| | | | | | | | CVE |
| xVDB | 6,387 | 1,644 | 3,020 | 2,966 | 1,766 | 12,458 | 12,458 |
| | | | | | | | Posts |

R*: Repositories
IT^{†}: Issue trackers
QA^{††}: Q&A sites

Referring to Table 4, in case of the conventional ‘PatchDB’, only the security patch provided from the ‘Git’ data source is collected in the ‘NVD’ which is the vulnerability public database (only a C/C++ security patch is considered). As a result, 4076 CVE patches are collected.

In the case of ‘xVDB’ according to the present disclosure, 12432 CVE patches and furthermore, 12458 insecure posts in the Q&A site are collected by considering even the hidden connectivity of the ‘NVD’ and the security patch by targeting the repository, the issue tracker, and the Q&A site (in the case of the CVE patch, C/C++, Java, JavaScript, and Go, Python patches are considered, and in the case of the insecure post, C/C++, and Android posts are considered). This indicates a result which is extended approximately 3 times more than the CVE patch as compared with the conventional study.

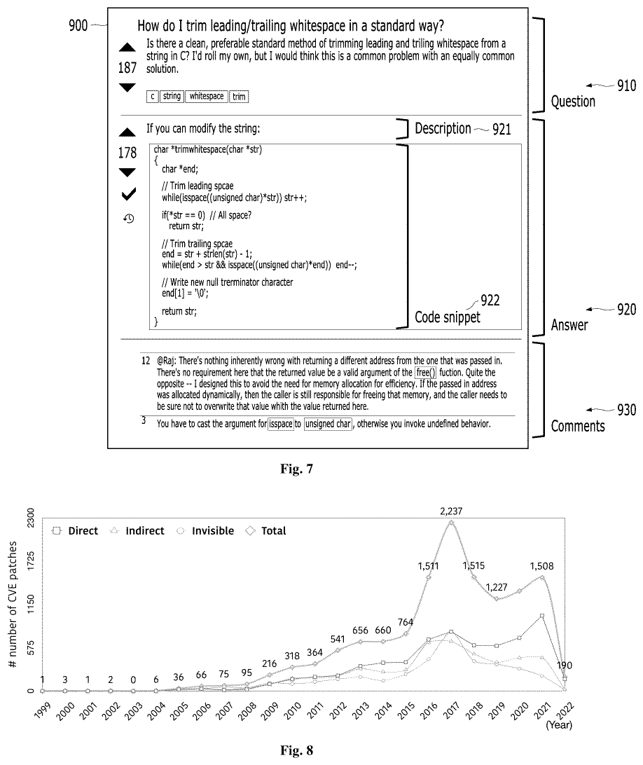

FIG. 8 is a graph of the year distribution of CVE patches in xVDB according to some exemplary embodiments of the present disclosure.

Referring to FIG. 8, it can be seen that more than half of patches collected by year are collected based on the indirect patch link and the invisible patch link.

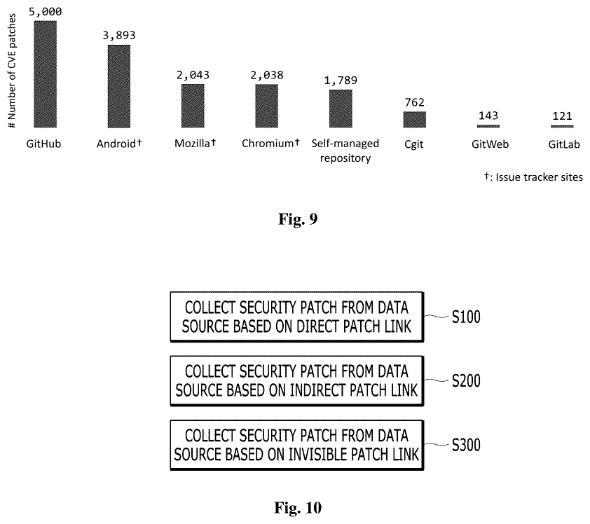

FIG. 9 is a graph of the distribution of reference sites of CVE patches in xVDB according to some exemplary embodiments of the present disclosure.

Further, referring to FIG. 9, a large number of security patches are collected through the issue tracker.

FIG. 10 is a flowchart of a method for building a vulnerability database according to some exemplary embodiments of the present disclosure.

According to some exemplary embodiments of the present disclosure, the method for building the vulnerability database may include a step (s100) of collecting the security patch from the data source based on the direct patch link.

According to some exemplary embodiments of the present disclosure, the method for building the vulnerability database may include a step (s200) of collecting the security patch from the data source based on the indirect patch link.

According to some exemplary embodiments of the present disclosure, the method for building the vulnerability database may include a step (s300) of collecting the security patch from the data source based on the invisible patch link.

The steps of the method described above are simply presented for description, and some steps may be omitted or additional steps may be added. In addition, the above-described steps may be performed in any order.

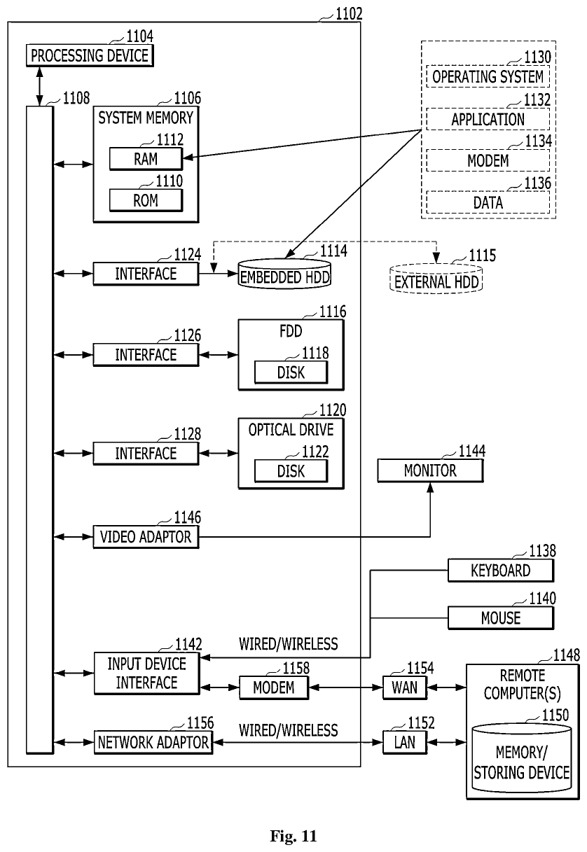

FIG. 11 is a block diagram of a computing device according to some exemplary embodiments of the present disclosure.

FIG. 11 is a simple and general schematic diagram illustrating an example of a computing environment in which the exemplary embodiments of the present disclosure are implementable.

The present disclosure has been generally described in relation to a computer executable command executable in one or more computers, but those skilled in the art will appreciate that the present disclosure is combined with other program modules and/or be implemented by a combination of hardware and software.

In general, a module in the present specification includes a routine, a procedure, a program, a component, a data structure, and the like performing a specific task or implementing a specific abstract data form. Further, those skilled in the art will appreciate well that the method of the present disclosure may be carried out by a personal computer, a hand-held computing device, a microprocessor-based or programmable home appliance (each of which may be connected with one or more relevant devices and be operated), and other computer system configurations, as well as a single-processor or multiprocessor computer system, a mini computer, and a main frame computer.

The exemplary embodiments of the present disclosure may be carried out in a distribution computing environment, in which certain tasks are performed by remote processing devices connected through a communication network. In the distribution computing environment, a program module may be positioned in both a local memory storage device and a remote memory storage device.

The computer generally includes various computer readable media. The computer readable medium is a computer accessible medium, and includes volatile and non-volatile media, transitory and non-transitory media, and portable and non-portable media. As a non-limited example, the computer readable medium may include a computer readable storage medium and a computer readable transmission medium.

The computer readable storage medium includes volatile and non-volatile media, transitory and non-transitory media, and portable and non-portable media constructed by a predetermined method or technology, which stores information, such as a computer readable command, a data structure, a program module, or other data. The computer readable storage medium includes a Random Access Memory (RAM), a Read Only Memory (ROM), an Electrically Erasable and Programmable ROM (EEPROM), a flash memory, or other memory technologies, a Compact Disc (CD)-ROM, a Digital Video Disk (DVD), or other optical disk storage devices, a magnetic cassette, a magnetic tape, a magnetic disk storage device, or other magnetic storage device, or other predetermined media, which are accessible by a computer and are used for storing desired information, but is not limited thereto.

The computer readable transport medium implements a computer readable command, a data structure, a program module, or other data in a modulated data signal, such as a carrier wave or other transport mechanisms, and generally includes all of the information transport media. The modulated data signal means a signal, of which one or more of the characteristics are set or changed so as to encode information within the signal. As a non-limited example, the computer readable transport medium includes a wired medium, such as a wired network or a direct-wired connection, and a wireless medium, such as sound, radio frequency (RF), infrared rays, and other wireless media. A combination of the predetermined media among the foregoing media is also included in a range of the computer readable transport medium.

An illustrative environment 1100 including a computer 1102 and implementing several aspects of the present disclosure is illustrated, and the computer 1102 includes a processing device 1104, a system memory 1106, and a system bus 1108. The system bus 1108 connects system components including the system memory 1106 (not limited) to the processing device 1104. The processing device 1104 may be a predetermined processor among various common processors. A dual processor and other multi-processor architectures may also be used as the processing device 1104.

The system bus 1108 may be a predetermined one among several types of bus structure, which may be additionally connectable to a local bus using a predetermined one among a memory bus, a peripheral device bus, and various common bus architectures. The system memory 1106 includes a ROM 1110, and a RAM 1112. A basic input/output system (BIOS) is stored in a non-volatile memory 1110, such as a ROM, an erasable and programmable ROM (EPROM), and an EEPROM, and the BIOS includes a basic routine helping a transport of information among the constituent elements within the computer 1102 at a specific time, such as starting. The RAM 1112 may also include a high-rate RAM, such as a static RAM, for caching data.

The computer 1102 also includes an embedded hard disk drive (HDD) 1114 (for example, enhanced integrated drive electronics (EIDE) and serial advanced technology attachment (SATA))—the embedded HDD 1114 being configured for outer mounted usage within a proper chassis (not illustrated)—a magnetic floppy disk drive (FDD) 1116 (for example, which is for reading data from a portable diskette 1118 or recording data in the portable diskette 1118), and an optical disk drive 1120 (for example, which is for reading a CD-ROM disk 1122, or reading data from other high-capacity optical media, such as a DVD, or recording data in the high-capacity optical media). A hard disk drive 1114, a magnetic disk drive 1116, and an optical disk drive 1120 may be connected to a system bus 1108 by a hard disk drive interface 1124, a magnetic disk drive interface 1126, and an optical drive interface 1128, respectively. An interface 1124 for implementing an outer mounted drive includes, for example, at least one of or both a universal serial bus (USB) and the Institute of Electrical and Electronics Engineers (IEEE) 1394 interface technology.

The drives and the computer readable media associated with the drives provide non-volatile storage of data, data structures, computer executable commands, and the like. In the case of the computer 1102, the drive and the medium correspond to the storage of predetermined data in an appropriate digital form. In the description of the computer readable storage media, the HDD, the portable magnetic disk, and the portable optical media, such as a CD, or a DVD, are mentioned, but those skilled in the art will appreciate well that other types of compute readable storage media, such as a zip drive, a magnetic cassette, a flash memory card, and a cartridge, may also be used in the illustrative operation environment, and the predetermined medium may include computer executable commands for performing the methods of the present disclosure.

A plurality of program modules including an operation system 1130, one or more application programs 1132, other program modules 1134, and program data 1136 may be stored in the drive and the RAM 1112. An entirety or a part of the operation system, the application, the module, and/or data may also be cached in the RAM 1112. It will be appreciated well that the present disclosure may be implemented by several commercially usable operation systems or a combination of operation systems.

A user may input a command and information to the computer 1102 through one or more wired/wireless input devices, for example, a keyboard 1138 and a pointing device, such as a mouse 1140. Other input devices (not illustrated) may be a microphone, an IR remote controller, a joystick, a game pad, a stylus pen, a touch screen, and the like. The foregoing and other input devices are frequently connected to the processing device 1104 through an input device interface 1142 connected to the system bus 1108, but may be connected by other interfaces, such as a parallel port, an IEEE 1394 serial port, a game port, a USB port, an IR interface, and other interfaces.

A monitor 1144 or other types of display devices are also connected to the system bus 1108 through an interface, such as a video adaptor 1146. In addition to the monitor 1144, the computer generally includes other peripheral output devices (not illustrated), such as a speaker and a printer.

The computer 1102 may be operated in a networked environment by using a logical connection to one or more remote computers, such as remote computer(s) 1148, through wired and/or wireless communication. The remote computer(s) 1148 may be a work station, a server computer, a router, a personal computer, a portable computer, a microprocessor-based entertainment device, a peer device, and other general network nodes, and generally includes some or an entirety of the constituent elements described for the computer 1102, but only a memory storage device 1150 is illustrated for simplicity. The illustrated logical connection includes a wired/wireless connection to a local area network (LAN) 1152 and/or a larger network, for example, a wide area network (WAN) 1154. The LAN and WAN networking environments are general in an office and a company, and make an enterprise-wide computer network, such as an Intranet, easy, and all of the LAN and WAN networking environments may be connected to a worldwide computer network, for example, Internet.

When the computer 1102 is used in the LAN networking environment, the computer 1102 is connected to the local network 1152 through a wired and/or wireless communication network interface or an adaptor 1156. The adaptor 1156 may make wired or wireless communication to the LAN 1152 easy, and the LAN 1152 also includes a wireless access point installed therein for the communication with the wireless adaptor 1156. When the computer 1102 is used in the WAN networking environment, the computer 1102 may include a modem 1158, is connected to a communication server on a WAN 1154, or includes other means setting communication through the WAN 1154 via the Internet. The modem 1158, which may be an embedded or outer-mounted and wired or wireless device, is connected to the system bus 1108 through a serial port interface 1142. In the networked environment, the program modules described for the computer 1102 or some of the program modules may be stored in a remote memory/storage device 1150. The illustrated network connection is illustrative, and those skilled in the art will appreciate well that other means setting a communication link between the computers may be used.

The computer 1102 performs an operation of communicating with a predetermined wireless device or entity, for example, a printer, a scanner, a desktop and/or portable computer, a portable data assistant (PDA), a communication satellite, predetermined equipment or place related to a wirelessly detectable tag, and a telephone, which is disposed by wireless communication and is operated. The operation includes a wireless fidelity (Wi-Fi) and Bluetooth wireless technology at least. Accordingly, the communication may have a pre-defined structure, such as a network in the related art, or may be simply ad hoc communication between at least two devices.

The Wi-Fi enables a connection to the Internet and the like even without a wire. The Wi-Fi is a wireless technology, such as a cellular phone, which enables the device, for example, the computer, to transmit and receive data indoors and outdoors, that is, in any place within a communication range of a base station. A Wi-Fi network uses a wireless technology, which is called IEEE 802.11 (a, b, g, etc.) for providing a safe, reliable, and high-rate wireless connection. The Wi-Fi may be used for connecting the computer to the computer, the Internet, and the wired network (IEEE 802.3 or Ethernet is used). The Wi-Fi network may be operated at, for example, a data rate of 11 Mbps (802.11a) or 54 Mbps (802.11b) in an unauthorized 2.4 and 5 GHz wireless band, or may be operated in a product including both bands (dual bands).

Those skilled in the art will appreciate that the various illustrative logical blocks, modules, processors, means, circuits, and algorithm operations described in relation to the exemplary embodiments disclosed herein may be implemented by electronic hardware (for convenience, called “software” herein), various forms of program or design code, or a combination thereof. In order to clearly describe compatibility of the hardware and the software, various illustrative components, blocks, modules, circuits, and operations are generally illustrated above in relation to the functions of the hardware and the software. Whether the function is implemented as hardware or software depends on design limits given to a specific application or an entire system. Those skilled in the art may perform the function described by various schemes for each specific application, but it shall not be construed that the determinations of the performance depart from the scope of the present disclosure.

Various exemplary embodiments presented herein may be implemented by a method, a device, or a manufactured article using a standard programming and/or engineering technology. A term “manufactured article” includes a computer program, a carrier, or a medium accessible from a predetermined computer-readable device. For example, the computer-readable storage medium includes a magnetic storage device (for example, a hard disk, a floppy disk, and a magnetic strip), an optical disk (for example, a CD and a DVD), a smart card, and a flash memory device (for example, an EEPROM, a card, a stick, and a key drive), but is not limited thereto. A term “machine-readable medium” includes a wireless channel and various other media, which are capable of storing, holding, and/or transporting a command(s) and/or data, but is not limited thereto.

It shall be understood that a specific order or a hierarchical structure of the operations included in the presented processes is an example of illustrative accesses. It shall be understood that a specific order or a hierarchical structure of the operations included in the processes may be re-arranged within the scope of the present disclosure based on design priorities. The accompanying method claims provide various operations of elements in a sample order, but it does not mean that the claims are limited to the presented specific order or hierarchical structure.

The description of the presented exemplary embodiments is provided so as for those skilled in the art to use or carry out the present disclosure. Various modifications of the exemplary embodiments may be apparent to those skilled in the art, and general principles defined herein may be applied to other exemplary embodiments without departing from the scope of the present disclosure. Accordingly, the present disclosure is not limited to the exemplary embodiments suggested herein, and shall be interpreted within the broadest meaning range consistent to the principles and new characteristics suggested herein.

What is claimed is:

1. A method for building a vulnerability database, which is performed by a computing device, comprising: collecting a security patch from a data source based on a direct patch link;
collecting the security patch from the data source based on an indirect patch link; and
collecting the security patch from the data source based on an invisible patch link.

2. The method of claim 1, wherein the collecting of the security patch from the data source based on the direct patch link includes
identifying a security patch link having a predetermined pattern on a vulnerability information page, and
collecting the security patch from a security patch page connected through the security patch link.

3. The method of claim 2, wherein the predetermined pattern includes vulnerability data source domain name information and security patch identification character string information.

4. The method of claim 1, wherein the collecting of the security patch from the data source based on the indirect patch link includes
crawling a website address identified on a vulnerability information page,
acquiring a security patch link having a predetermined pattern or predetermined hint information, and
collecting the security patch based on the security patch link or the predetermined hint information.

5. The method of claim 4, wherein the collecting of the security patch based on the security patch link or the predetermined hint information includes
collecting the security patch from a security patch page connected through the security patch link.

6. The method of claim 5, wherein the predetermined pattern includes vulnerability data source domain name information and security patch identification character string information.

7. The method of claim 4, wherein the collecting of the security patch based on the security patch link or the predetermined hint information includes
collecting a patch commit corresponding to the predetermined hint information.

8. The method of claim 7, wherein the predetermined hint information includes commit ID information or bug ID information.

9. The method of claim 1, wherein the collecting of the security patch from the data source based on the invisible patch link includes
collecting a Q&A post from a Q&A site,
extracting a change history of the collected Q&A post,
identifying change information corresponding to a predetermined feature from the extracted change history, and
acquiring an insecure code snippet based on the identified change information.

10. The method of claim 9, wherein the predetermined feature includes changes in a security-sensitive API, a security-related keyword, and a control flow.

11. The method of claim 1, wherein the collecting of the security patch from the data source based on the invisible patch link includes
searching a commit message including CVE ID information in a repository or an issue tracker, and
collecting the security patch from the searched commit message by analyzing the searched commit message based on a predetermined feature.

12. A computer program stored in a computer-readable medium, wherein the computer program includes instructions for allowing one or more processors to perform a method for building a vulnerability database, the method comprising:
collecting a security patch from a data source based on a direct patch link;
collecting the security patch from the data source based on an indirect patch link; and
collecting the security patch from the data source based on an invisible patch link.

13. A computing device for performing a method for building a vulnerability database, the computing device comprising:
a memory including computer executable components; and
a processor executing following computer executable components stored in the memory,
wherein the processor
collects a security patch from a data source based on a direct patch link,
collects the security patch from the data source based on an indirect patch link, and
collects the security patch from the data source based on an invisible patch link.
